(19) United States
(12) Patent Application Publication
(10) Pub. No.: US 2017/0225967 A1
(43) Pub. Date: Aug. 10, 2017

(54) Use of Magnetic Mesoporous Silica Nanoparticles For Removing Uranium From Media

(71) Applicants: Savannah River Nuclear Solutions, LLC, Aiken, SC (US); University of Iowa Research Foundation, Iowa City, IA (US)

(72) Inventors: Dien Li, Martinez, GA (US); Daniel I. Kaplan, Aiken, SC (US); Steven M. Serkiz, Aiken, SC (US); Sarah C. Larsen, Iowa City, IA (US); Shani Egodawatte, Iowa City, IA (US)

(21) Appl. No.: 15/018,213

(22) Filed: Feb. 8, 2016

(51) Int. Cl. C02F 1/28; G21F 9/12; B01J 20/28; C02F 1/48; B01J 20/10; B01J 20/02

(52) U.S. Cl. CPC C02F 1/281; B01J 20/103; B01J 20/0225; B01J 20/28009; B01J 20/28004; B01J 20/28007; B01J 20/2808; B01J 20/28083; B01J 20/28059; B01J 20/28061; B01J 20/28064; B01J 20/28066; C02F 1/488; G21F 9/12; C02F 2101/006

(57) ABSTRACT

The present invention is directed to a method of removing uranium from a uranium containing aqueous medium. The method comprises a step of contacting the medium with magnetic mesoporous silica nanoparticles. The nanoparticles comprise mesoporous silica and iron oxide. The nanoparticles may also comprise a functionalized surface obtained by grafting or covalently bonding a functional molecule to the nanoparticle.

### FEDERAL RESEARCH STATEMENT

This invention was made with Government support under Contract No. DE-AC09-085R22470, awarded by the U.S. Department of Energy. The Government has certain rights in the invention.

### BACKGROUND OF THE INVENTION

Uranium is the one of the most common radioactive contaminants. In general, it can be present in the natural environment as well as in waste streams. As a result, there is a need to provide an effective method for removing uranium in order to reduce any potential health hazards and concerns. Various methods, such as ion exchange resins and amorphous carbon, have been employed for removing uranium from a medium, such as an aqueous medium. However, there are many drawbacks to these methods including costs, inefficiency, etc.

As a result, there is a need to provide a method for effectively removing uranium from various media.

### SUMMARY OF THE INVENTION

Aspects and advantages of the invention will be set forth in part in the following description, or may be apparent from the description, or may be learned through practice of the invention.

The present invention is directed to a method for removing uranium from a uranium containing aqueous medium. The method comprises a step of contacting the medium with magnetic mesoporous silica nanoparticles each comprising mesoporous silica and iron oxide.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides the transmission electron microscopy (TEM) images of the functionalized magnetic mesoporous silica nanoparticles;

FIGS. 2a, 2b, and 2c provide the ¹³C CPMAS NMR spectra and corresponding structures of the functional molecules;

FIG. 3 provides the XRD patterns of the functionalized magnetic mesoporous silica nanoparticles;

FIG. 4 provides a graph of the adsorption coefficients for the adsorption of uranium onto the functionalized magnetic mesoporous silica nanoparticles when in artificial groundwater at a pH of 3.5 and a pH of 9.6;

FIG. 5 provides the isotherm curves for the adsorption of uranium onto the functionalized magnetic mesoporous silica nanoparticles when in artificial groundwater at a pH of 3.5 and a pH of 9.6;

FIG. 6 provides a graph of the adsorption coefficients for the adsorption of uranium onto the functionalized magnetic mesoporous silica nanoparticles in low pH artificial groundwater; and

FIG. 7 provides the adsorption coefficients for uranium onto the functionalized magnetic mesoporous silica nanoparticles when in a seawater simulant at a pH of 8.1.

### DETAILED DESCRIPTION OF THE INVENTION

### Definitions

It is to be understood that the terminology used herein is for the purpose of describing particular embodiments only and is not intended to limit the scope of the present invention.

“Alkyl” refers to monovalent saturated aliphatic hydrocarbyl groups having from 1 to 10 carbon atoms and, in some embodiments, from 1 to 5 carbon atoms. “C_{x-y} alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH2CH₂), isobutyl ((CH₃)₂CHCH₂), sec-butyl ((CH₃)(CH₃CH₂)CH), t-butyl ((CH₃)₃C), n-pentyl (CH₃CH₂CH₂CH₂CH₂), and neopentyl ((CH₃)₃CCH₂).

“Alkenyl” refers to a linear or branched hydrocarbyl group having from 2 to 10 carbon atoms and in some embodiments from 2 to 6 carbon atoms or 2 to 5 carbon atoms and having at least 1 site of vinyl unsaturation (>C═C<). For example, (Cₓ—C_{y}) alkenyl refers to alkenyl groups having from x to y carbon atoms and is meant to include for example, ethenyl, propenyl, 1,3-butadienyl, and so forth.

“Aryl” refers to an aromatic group of from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Heteroaryl” refers to an aromatic group of from 1 to 14 carbon atoms and 1 to 6 heteroatoms selected from oxygen, nitrogen, and sulfur and includes single ring (e.g. imidazolyl) and multiple ring systems (e.g. benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g. 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from nitrogen, sulfur, or oxygen and includes single ring and multiple ring systems including fused, bridged, and Spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g. decahydroquinolin-6-yl). In some embodiments, the nitrogen and/or sulfur atom(s) of the heterocyclic group are optionally oxidized to provide for the N oxide, sulfinyl, sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned definitions encompass unsubstituted groups, as well as groups substituted with one or more other functional groups as is known in the art. For example, an aryl, heteroaryl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally speaking, the present invention is directed to a method for removing uranium from a uranium containing medium. For instance, the medium may be an aqueous medium containing at least uranium and water. In particular, the method requires a step of contacting the medium with a magnetic mesoporous silica nanoparticle.

The present inventors have discovered that use of the nanoparticles disclosed herein can provide a high surface area and result in high ion selectivity and binding capacity thereby increasing the efficiency of removing uranium from a medium. The present inventors have also discovered that these magnetic mesoporous silica nanoparticles can be used to effectively bind and remove uranium, even in extreme chemical environments such as extreme pH conditions. As a result, these nanoparticles can be used to extract aqueous uranium from various high-level or low-level nuclear waste streams, for remediation of uranium mining and processing sites, for clean-up of uranium after release from the detonation of a nuclear weapon, and for extraction of uranium from seawater.

As indicated above, the method disclosed herein requires a step of contacting a uranium containing medium with a magnetic mesoporous silica nanoparticle. In this regard, the magnetic mesoporous silica nanoparticle includes mesoporous silica and a magnetic component. Without intending to be limited by theory, it is believed that the magnetic component can allow for the separation of the nanoparticles from the medium with an external magnet while the mesoporous silica provides a high surface area that can be amenable for attaching organic functional groups if desired.

In one particular embodiment, the magnetic component may comprise iron oxide. It should be understood that the iron oxide may be any iron oxide known in the art that can provide magnetic properties. For instance, the iron oxide may be Fe₃O₄ or Fe₂O₃ or a combination thereof. For instance, the iron oxide may be magnetite (Fe₃O₄), hematite, maghemite (α- or γ-Fe₂O₃), or a combination thereof.

In addition, the iron oxide may also be magnetic such that it provides a magnetic property. It should be understood that even after synthesis of the nanoparticles, in some instances, the magnetic properties may not be present until further processing is conducted (e.g., reduction or oxidation).

The magnetism may be any kind that allows the nanoparticles to be drawn in a particular direction by the effect of a magnetic field. For instance, the magnetism can include ferromagnetism, ferrimagnetism, paramagnetism, diamagnetism, antiferromagnetism, and superparamagnetism.

In one embodiment, the mesoporous silica may be present as a coating on the magnetic component, such as the iron oxide. In one embodiment, the magnetic mesoporous silica nanoparticles may have a core-shell structure. For instance, the nanoparticles may have a core comprising iron oxide and a shell/coating comprising the mesoporous silica.

In one embodiment, the nanoparticle is functionalized. In this regard, the nanoparticle may be a functionalized magnetic mesoporous silica nanoparticle. The present inventors have discovered that such functionalization can enhance the ability of the nanoparticles to bind uranium.

In one embodiment, the nanoparticles comprise a functional group bound to the surface of the nanoparticle. The functional group may be derived from a functional molecule that is covalently bound to the nanoparticle.

In one embodiment, the functional group or molecule contains a sulfur atom, a phosphorus atom, a nitrogen atom, or a combination thereof. In one embodiment, the functional group or molecule may contain a thiol, a phosphine, a phosphonate, a phosphonite, an amine, a nitrogen containing heterocycle, or a combination thereof.

In one embodiment, the functional group may comprise an amine. The amine may be a primary amine, a secondary amine, or a tertiary amine. In one embodiment, the amine may be a nitrogen containing heterocycle. In one embodiment, the nitrogen containing heterocycle may be a nitrogen containing heteroaromatic. However, it should be understood that the functional group may comprise a primary amine, a secondary amine, or a tertiary amine in combination with a nitrogen containing heterocycle.

It should be understood that the nitrogen containing heterocycle may also include another heteroatom such as an oxygen or sulfur atom. For instance, the nitrogen containing heterocycle may include an aziridine, an azirine, a diazirine, an oxaziridine, an azetidine, an azete, a diazetidine, a pyrrolidine, a pyrrole, an imidazolidine, a pyrazolidine, an imidazole, a pyrazole, an oxazolidine, an isoxazolidine, an oxazole, an isoxazole, a thiazolidine, an isothiazolidine, a thiazole, an isothiazole, a triazole, a furazan, an oxadiazole, a thiadiazole, a dithiazole, a tetrazole, a piperidine, a pyridine, a piperazine, a diazine, a morpholine, an oxazine, a thiomorpholine, a thiazine, a triazine, a tetrazine, an azepane, an azepine, a homopiperazine, a diazepine, a thiazepine, an axocane, and an azocine.

In one embodiment, the nitrogen containing heterocycle may be an imidazole. In one embodiment, the imidazole may be dihydroimidazole. The imidazole, such as the dihydroimidazole, may be substituted or unsubstituted. In one embodiment, the dihydroimidazole may be N-(3-triethoxysilylpropyl)-4,5-dihydroimidazole.

In one embodiment, the nanoparticle may include an amine group. For instance, the amine group may be an aminoalkyl group. The alkyl may be a C₁₋₂₀ alkyl, such as a C₁₋₁₀ alkyl. In one embodiment, the aminoalkyl may contain more —NH—groups in the chain.

In one embodiment, the functional group may contain a phosphine.

In one embodiment, the functional group may contain a phosphonate, a phosphonite, or a combination thereof. Compounds that can provide this functionality include, but are not limited to 3-(trihydroxysilyl) propyl methylphosphonate, diethylphosphato-ethyltriethoxysilane, and the like.

In one embodiment, the functional groups can be obtained by binding a functional molecule that includes, but is not limited to, mercaptopropyl trimethoxysilane (“MPTMS”), benzoylthiourea (“BT”), aminopropyl triethoxysilane (“APTES”), N-(3-triethoxysilylpropyl)-4,5 dihydroimidazole (“DIM”), polyacryloamidoxime (“AD”), a phosphonate (“PP”) (e.g., a phosphonate amino (“PPA”), poly(amidoamine) dendrimer (“PAMAM”), polypropylenimine dendrimer (“PPI”), and the like.

As indicated above, the nanoparticles may have a mesoporous structure. In this regard, the nanoparticles can have pores such that the average diameter of the pores is 0.5 nm or greater, such as 1 nm or greater, such as 1.5 nm or greater, such as 2 nm or greater, such as 2.5 nm or greater, such as 3 nm or greater and 300 nm or less, such as 100 nm or less, such as 50 nm or less, such as 20 nm or less, such as 10 nm or less, such as 7.5 nm or less. The average pore diameter can be measured using any method generally known in the art. For instance, the pore diameter can be measured using the Barrett-Joyner-Halenda (BJH) sorption analysis method and performing a nitrogen adsorption-desorption isotherm.

In general, the nanoparticles may have an average diameter of 1 nm or greater, such as 2 nm or greater, such as 5 nm or greater, such as 10 nm or greater, such as 25 nm or greater, such as 50 nm or greater and 1000 nm or less, such as 500 nm or less, such as 250 nm or less, such as 100 nm or less, such as 50 nm or less, such as 25 nm or less, such as 20 nm or less, such as 15 nm or less, such as 10 nm or less. The average diameter can be measured using any method generally known in the art. For instance, the diameters can be measured using transmission electron microscopy and measuring the particle sizes. However, other particle size measurement techniques may also be used.

In general, the nanoparticles may have a surface area of 50 m²/g or greater, such as 100 m²/g or greater, such as 200 m²/g or greater, such as 250 m²/g or greater, such as 400 m²/g or greater and 3000 m²/g or less, such as 2000 m²/g or less, such as 2500 m²/g or less, such as 1000 m²/g or less, such as 750 m²/g or less, such as 500 m²/g or less, such as 400 m²/g or less. The surface area can be determined using any method generally known in the art. For instance, the surface area can be measured by conducting a Brunauer, Emmett and Teller (BET) analysis and using a nitrogen adsorption isotherm.

In general, the magnetic mesoporous silica nanoparticles can be synthesized using any method generally known in the art. For instance, the nanoparticles can be produced according to methods disclosed by Feng et al., Science, 1997, 276 (5314), 923-926 as well as Wu et al., Adv. Funct. Mater., 2004, 14 (4), 345-351, both of which are incorporated herein in their entirety. The nanoparticles can also be functionalized using any method known in the art. For instance, examples for functionalizing the nanoparticles are disclosed in Barquist et al., Microporous Mesoporous Mater., 2008, 116 (1-3), 365-369; Fryxell et al., J. Mater. Chem. 2007, 17 (28), 2863-2874; and Bruce et al., Langmuir, 2005, 21 (15), 7029-7035, all of which are incorporated herein in their entirety.

According to one method, a core comprising a magnetic component, such as an iron oxide, can be synthesized. Such synthesis can include a controlled precipitation of FeCl₃ and/or FeCl₂ with ammonia hydroxide. However, it should be understood that any method can be employed for synthesizing the core. Thereafter, a surfactant-template self-assembling method using a silica material (e.g., tetraethyl orthosilicate, etc.) can be employed to create a mesoporous silica coating on the core. Then, if desired, functionalized nanoparticles can be synthesized by grafting or bonding selected molecules or functional groups onto the nanoparticles, such as the surface of the nanoparticles. While this is one method, it should be understood that other methods may be employed for synthesizing the nanoparticles.

The nanoparticles can also be synthesized according to methods disclosed in U.S. Pat. No. 8,828,705 to Lin et al., U.S. Patent Application Publication No 2006/0154069 to Lin et al., U.S. Patent Application Publication No. 2006/0018966 to Lin et al., or Linton et al., Chem. Mater. 2008, 20, 2878-2880, all of which are incorporated herein in their entirety. For instance, a mesoporous silica nanoparticle may first be synthesized. Thereafter, the mesoporous silica nanoparticles can be transformed into a magnetic mesoporous silica nanoparticle by contacting the nanoparticle with iron oxide or an iron oxide precursor, optionally followed by a reduction or oxidation step.

In general, the mesoporous silica contains repeating —O—Si(R)₂— units, which form the silica matrix. The R group may be any suitable substituent, including for example, siloxy, alkoxy, halo, or alkyl, wherein alkoxy or alkyl can be for example C₁₋₂₀ branched or straight chain. It should be understood that the repeating —O—Si(R)₂— units can be bound to any other suitable unit in the matrix, such as another silicon atom or an alkoxy group. It should be understood that any method known in the art may be used to synthesize the mesoporous silica.

In one embodiment, the mesoporous silica can be made by condensing an alkoxysilane. The alkoxysilane can be tetramethylorthosilica (TMOS), tetraethylorthosilicate (TEOS), tetrakis(2-hydroxyethyl)orthosilica (THEOS), methyldiethoxysilane (MDES), 3-(glycidoxypropyl)triethoxysilane (GPTMS), 3-(trimethyoxysilyl)propylacrylate (TMSPA), N-(3-triethoxysilylpropyl)pyrrole (TESPP), vinyltriethyoxysilane (VTES), methacryloxypropyltriethoxysilane (TESPM), diglycerylsilane (DGS), methyltriethoxysilane (MTMOS), trimethylmethoxysilane (TMMS), ethyltriethoxysilane (TEES), n-propyltriethoxysilane (TEPS), n-butyltriethyoxysilane (TEBS), 3-aminopropyltriethoxysilane (APTES), 2-(2,4-dinitrophenylamino)propyltriethoxysilane, mercaptopropyltriethoxysilane (TEPMS), 2-(3-aminoethylamino)propyltriethoxysilane, isocyanatopropyltriethoxysilane, hydroxyl-terminated polydimethylsiloxane, triethoxysilyl-terminated polydimethylsiloxane, methyltriethoxysilane (MTES), or triethoxysilyl-terminated poly(oxypropylene).

In one embodiment, acid or base treatment can allow hydrolysis of the alkoxysilane to give a reactive silanol, which can then react with other alkoxysilanes or silanols (e.g., to form —Si(R)₂—O—Si(R)₂— units) or with other reactive groups. In some embodiments, a reactive silanol can be provided by treatment of silica (e.g., SiO₂) with an acid or a base. Hydroxyl groups (e.g., R′—OH, wherein R′ is any suitable substituent of suitable valency, e.g., monovalent or divalent) from other compounds can condense with alkoxysilanes or silanols to give substituted silicones (e.g., —Si(R)₂—O—R′). Any suitable compound (e.g. silicon-containing or non-silicon containing) having any suitable number of hydroxyl or alkoxy groups (e.g. 1, 2, 3, 4, or more) can participate in the condensation, such that a wide variety of structures are possible for the mesoporous silica nanoparticle. In addition, the silanol groups on the surface and pores of the nanoparticles can be utilized to facilitate surface functionalization if desired.

As indicated above, the iron oxide nanoparticles can be synthesized from FeCl₂ and/or FeCl₂. However, iron oxide precursors may also include Fe(NO₃)₃. 9H₂O, (NH₄)₂Fe(SO₄)₂, NH₄Fe(SO₄)₂, FeO, Fe₃O₄, Fe₂O₃, FeOCl, FeS, Fe(OAc)₂, FeX₂ or FeX₃ wherein X is independently chloro, bromo, or fluoro, Fe₃(PO₄)₂, FeSO₄, FeTiO₃, Fe(NO₃)₃, and the like, or any hydrate thereof. The reduction or oxidation is an optional step and may be performed if necessary using any method generally known in the art. For instance, reduction can be performed via application of H₂ gas with or without heating.

As mentioned herein, the magnetic mesoporous silica nanoparticles can be used to bind and remove uranium from a uranium containing aqueous medium. The aqueous medium refers to a water-containing environment. For instance, such medium may contain water in an amount of at least 10% by weight, such as at least 25% by weight, such as at least 50% by weight, such as at least 75% by weight, such as at least 90% by weight, such as at least 95% by weight. However, it should be understood that the medium may also contain other components, such as organic solvents, acids/bases, dissolved species, dispersing agents, non-solubles, etc.

In this regard, the magnetic mesoporous silica nanoparticles may be present in the medium in an amount of about 0.001% or greater, such as about 0.005% or greater, such as about 0.01% or greater, such as about 0.1% or greater, such as about 1% or greater, such as about 0.5% or greater, such as about 1% or greater, such as about 2% or greater and about 50% or less, such as about 25% or less, such as about 15% or less, such as about 10% or less, wherein the % is based on the mass of the nanoparticles and the volume of the medium (e.g., 10% m/v equals 10 g of the nanoparticles per 100 mL of the medium).

The present method requires a step of contacting the medium with a magnetic mesoporous silica nanoparticle. The nanoparticles can be exposed to the medium for a sufficient time to allow binding of the uranium to the nanoparticles. Such time may be at least 1 minute, such as at least 5 minutes, such as at least 15 minutes, such as at least 30 minutes. However, it should be understood that contacting is generally sufficient to adsorb or bind the uranium to the pores or surface of the magnetic mesoporous silica nanoparticles.

In a further embodiment, the method may also include a step of exposing the nanoparticles to a magnet/magnetic field. In one particular embodiment, the nanoparticles may contain adsorbed uranium. Thus, such exposure may concentrate the uranium, such as the adsorbed uranium. In addition, the magnetic component allows the nanoparticles to be separated and recovered easily by using an external magnet/magnetic field.

The magnetic field can be generated using any method known in the art. In one embodiment, the magnetic field can be generated by an electromagnet, a non-electromagnet, or a combination thereof.

In one embodiment, the method further provides a step of separating the magnetic mesoporous silica nanoparticles from the medium. The separation can be conducted using any method known in the art. For instance, these techniques include draining the medium, centrifuging, gravity, etc.

In one embodiment, the method further provides a step of desorbing or debonding the uranium from the nanoparticles. This can be done according to any method known in the art. For instance, any method of altering the interaction between the uranium and the nanoparticles can be used to cause desorption. Such methods may include sonication, agitation, heating, cooling, addition of a chemical compound, etc. For instance, an acid, such as nitric acid or the like, can be introduced in order to desorb, debond, or initiate desorption or debonding of the uranium from the nanoparticles. The acid may be at a concentration of from 1 to 20%, such as from 1 to 10%, such as from 1 to 5%.

In one embodiment, after removing the uranium from the nanoparticles, the magnetic mesoporous silica nanoparticles can be recycled and reused for another adsorption cycle.

It should be understood that the method disclosed herein provides for efficient removal of uranium from a medium. For instance, by measuring the initial concentration of the uranium in the medium and the final concentration of uranium in the medium after removal of the nanoparticles, the present inventors have discovered that the uranium may be removed in an amount of at least 10% by weight, such as at least 25% by weight, such as at least 50% by weight, such as at least 75% by weight, such as at last 90% by weight, such as at least 95% by weight, such as at least 97% by weight.

The present inventors have discovered that while the MMSNs are effective for binding uranium, they may be particularly effective when the media is at a pH of from 2.5 to 4 or a pH of from 9 to 10, while other sorbent materials may not work as effectively under such pH conditions, and when under atmospheric P_{CO2} of 10^{-3.5} atm. In fact, the present inventors discovered that 2 to 6 orders of magnitude greater of uranium was removed from groundwater by using the functionalized magnetic mesoporous silica nanoparticles in comparison to unfunctionalized nanoparticles or a fine silica sorbent material.

The present inventors have discovered that when at a pH of from 2.5 to 4, such as about 3 or 3.5, the uranium concentration may be reduced to a concentration of 500 μg/L or less, such as 300 μg/L or less, such as 200 μg/L or less, such as 150 μg/L or less. The present inventors have also discovered that when at a pH of from 9 to 10, such as 9.6, the uranium concentration may be reduced to a concentration of 200 μg/L or less, such as 100 μg/L or less, such as 50 μg/L or less, such as 25 μg/L or less, such as 10 μg/L or less, such as 5 μg/L or less, such as 1 μg/L or less.

In addition, according to the present method, the uranium removal may be 50% by weight or greater, such 75% by weight or greater, such as 85% by weight or greater, such as 90% by weight or greater, such as 95% by weight or greater, such as 97% by weight or greater, such as 98% by weight or greater and generally 100% by weight or less. Such removal can occur when at various pH levels, including a pH of 3 and a pH of 9.6.

As utilized in the examples, in order to assess the effectiveness of the nanoparticles for binding uranium, the adsorption coefficient (K_{d} in mL/g) can be determined and analyzed. For instance, the adsorption coefficient can be determined using the formula: K_{d}=((C₀-C)/C)*(V/M) wherein C₀ and C are the initial and final concentration of the uranium in solution, V is the volume of the medium (e.g., aqueous media) in mL, and M is the mass of nanoparticles in grams.

As used herein, adsorption coefficient was determined via batch experiments under the following conditions: initial uranium concentration of 2.5×10⁻⁵ mole/liter, volume of media was 7.5 mL, mass of the nanoparticles was 0.075 grams, temperature was room temperature (˜20-24° C.), atmospheric P_{CO2} of 10^{-3.5} atm. Such test can be conducted in accordance with ASTM C1733-10 (2010).

### EXAMPLES

### Example 1

### Synthesis of Magnetite (Fe₃O₄) Nanoparticles

Ferric chloride (4.80 g) and ferrous chloride (2.00 g) were dissolved in deionized water (30 ml) and were allowed to stir under nitrogen atmosphere until the temperature of the solution was maintained at 90° C. Ammonium hydroxide (20 ml) was added to precipitate the iron sources and the contents were aged for 2.5 hours. The contents were filtered and washed with water.

### Example 2

### Synthesis of Magnetic Mesoporous Silica Nanoparticles (MMSNs)

Hexadecyltrimethylammoniumbromide (CTAB), NaOH, and water were mixed with Fe₃O₄ (300 mg) and thereafter sonicated. The contents were heated at 80° C. and the silica source, tetraethylorthosilicate (TEOS), was added. The reaction mixture was aged for 2 hours. Then it was filtered, washed with water and methanol, and dried at 100° C. overnight. The template was extracted by calcining the product to 600° C. for 6 h.

### Example 3

### Synthesis of Mesoporous Silica Nanoparticles (MSNs)

The mesoporous silica nanoparticles (MSNs) were prepared in the same manner as Example 2 except there was no addition of Fe₃O₄ nanoparticles. Instead, MCM-41 was employed.

### Example 4

### MPTMS Functionalized MMSNs (MMSNs-MPTMS)

Calcined MMSNs (1 g) was refluxed with MPTMS (8 mmol) in toluene for 120° C. for 6 hours. The reaction mixture was filtered and washed with excess toluene followed by a 1:1 mixture of diethylether and dichloromethane, dried at 100° C. overnight in an oven.

### Example 5

### Benzoylthiourea Functionalized MMSNs (MMSNs-BT)

APTES functionalized silica (1 g) was refluxed with benzoyl thiourea (8 mmol) in toluene for 120° C. for 6 hours. The reaction mixture was filtered and washed with toluene and 1-propanol, dried at 100° C. overnight in an oven.

### Example 6

### APTES Functionalized MMSNs (MMSNs-APTES)

Calcined MMSNs (1 g) was refluxed with APTES (8 mmol) in toluene for 120° C. for 6 hours. The reaction mixture was filtered and washed with 1:1 mixture of diethylether and dichloromethane, dried at 100° C. overnight in an oven.

### Example 7

### Dihydroimidazole Functionalized MMSNs (MMSNs-DIM)

Calcined MMSNs (1 g) was refluxed with dihydroimidazole silane (4 mmol) in toluene for 120° C. for 4 hours. The reaction mixture was filtered and washed with excess toluene followed by a 1:1 mixture of diethylether and dichloromethane, dried at 100° C. overnight in an oven.

### Example 8

### Polyacryloamidoxime Functionalized MMSNs (MMSNs-AD)

APTES functionalized silica (1 g) was refluxed with acrylonitrile (8 mmol) in methanol at 65° C. for 12 h under nitrogen atmosphere. The reaction mixture was filtered and washed with 1:1 mixture of diethylether and dichloromethane, dried at 50° C. overnight in an oven. Next the product obtained from the above reaction was mixed with 0.5 g of NH₂OH.HCl and 50 ml of Methanol. The pH of the reaction was adjusted to 8 and it was heated at 70° C. for 24 hrs. The solution was filtered and washed with methanol and dried at 50° C. overnight in an oven.

### Example 9

### Phosphonate Functionalized MMSNs (MMSNs-PP)

Calcined MSNs (1 g) was refluxed with 3-(trihydroxysilyl) propyl methylphosphonate (4 mmol) in toluene for 120° C. for 4 hours. The reaction mixture is filtered and washed with 1:1 mixture of diethylether and dichloromethane, dried at 100° C. overnight in an oven.

### Example 10

### Phosphonate-Amino Functionalized MMSNs (MMSNs-PPA)

Calcined MSNs (1 g) was refluxed with APTES and Diethylphosphato-ethyltriethoxysilane (DPTS) (4 mmol of each functional group) in toluene for 120° C. for 6 hours. The reaction mixture is filtered and washed with 1:1 mixture of diethylether and dichloromethane, dried at 100° C. overnight in an oven.

### Example 11

### Poly(amidoamine) Dendrimer Functionalized MMSNs (MMSNs-PAMAM)

Calcined APTES functionalized MMSNs (0.5 g) and poly(amidoamine) (PAMAM) (0.2 ml) were dissolved in methanol (20 ml) and was heated at 50° C. for 24 hours. The particles are centrifuged and washed with methanol.

### Example 12

### Poly(propylenimine) Dendrimer Functionalized MMSNs (MMSNs-PPI)

Calcined APTES functionalized MMSNs (0.3 g) and poly(propylenimine) (PPI) dendrimer (0.2 ml) were dissolved in methanol (50 ml) and was heated as refluxed for 24 hours. The particles are centrifuged and washed with methanol.

### Example 13

### Surface Area, Functionalization, Fe Content, and TEM

The surface area, amount of functionalized molecules, and Fe content of each batch of these nanoparticles was determined. The surface area was determined by nitrogen adsorption and the BET method. The amount of functionalized molecules was determined by thermal gravimetric analysis (TGA) method. The Fe content was determined by chemical analysis. The data is represented in Table 1 below.

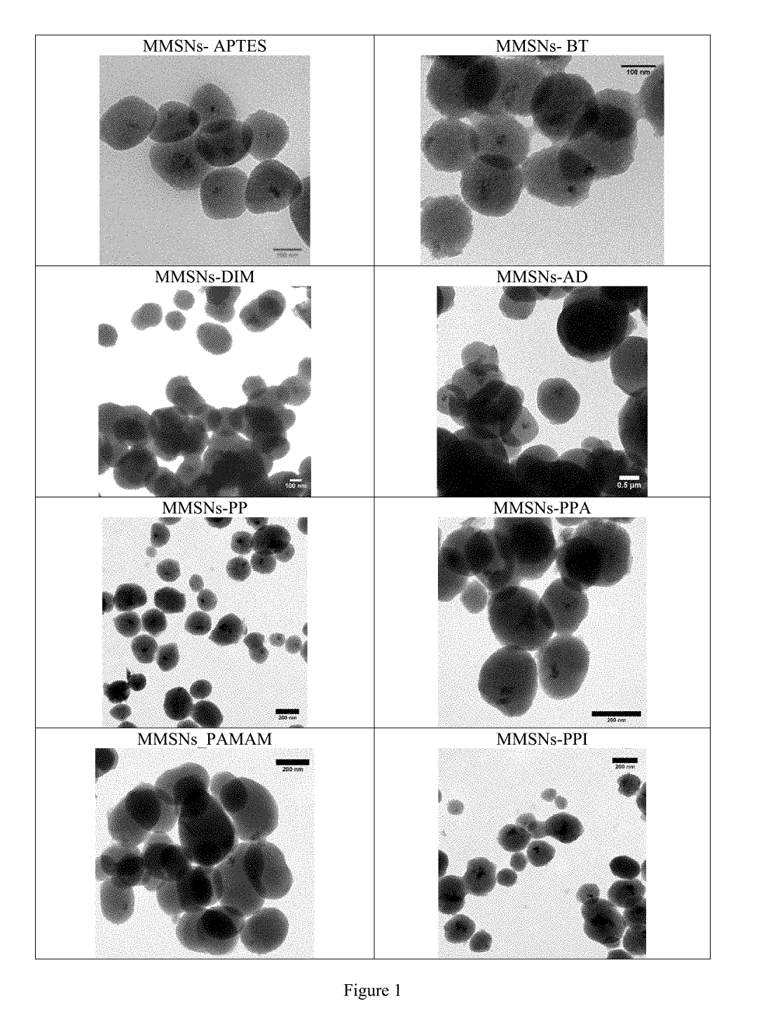

In addition, transmission electron microscope images of the functionalized MMSNs were obtained. These are shown in FIG. 1.

TABLE 1
Surface Area, Functionalization, and Fe Content

| | Surface Area | Functionalization | Fe content |
|---|---|---|---|
| Samples | (m²/g) | (mmol/g) | (%) |
| MSNs | 1210 | — | — |
| MSNs-MPTMS | 629 | 0.7516 | — |
| MSNs-BT | 581 | 0.7190 | — |
| MSNs-APTES | 536 | 0.5981 | — |
| MSNs-DIM | 621 | 0.4930 | — |
| MSNs-AD | 777 | 0.4734 | — |
| MMSNs | 1010 | — | 13.4 |
| MMSNs-MPTMS | 629 | 0.5636 | 13.4 |
| MMSNs-BT | 541 | 0.7872 | 9.7 |
| MMSNs-APTES | 528 | 0.4155 | 12.5 |
| MMSNs-DIM | 529 | 0.6421 | 9.9 |
| MMSNs-AD | 602 | 0.3622 | 14.7 |
| MMSNs-PP | 512 | 0.2297 | 23 |
| MMSNs-PPA | 475 | 0.1852-A | 19 |
| | | 0.3040-PP | |
| MMSNs-PAMAM | 635 | 0.00802 | 20 |
| MMSNs-PPI | 592 | 0.4789 | 13 |

### Example 14

### ¹³C CPMAS NMR

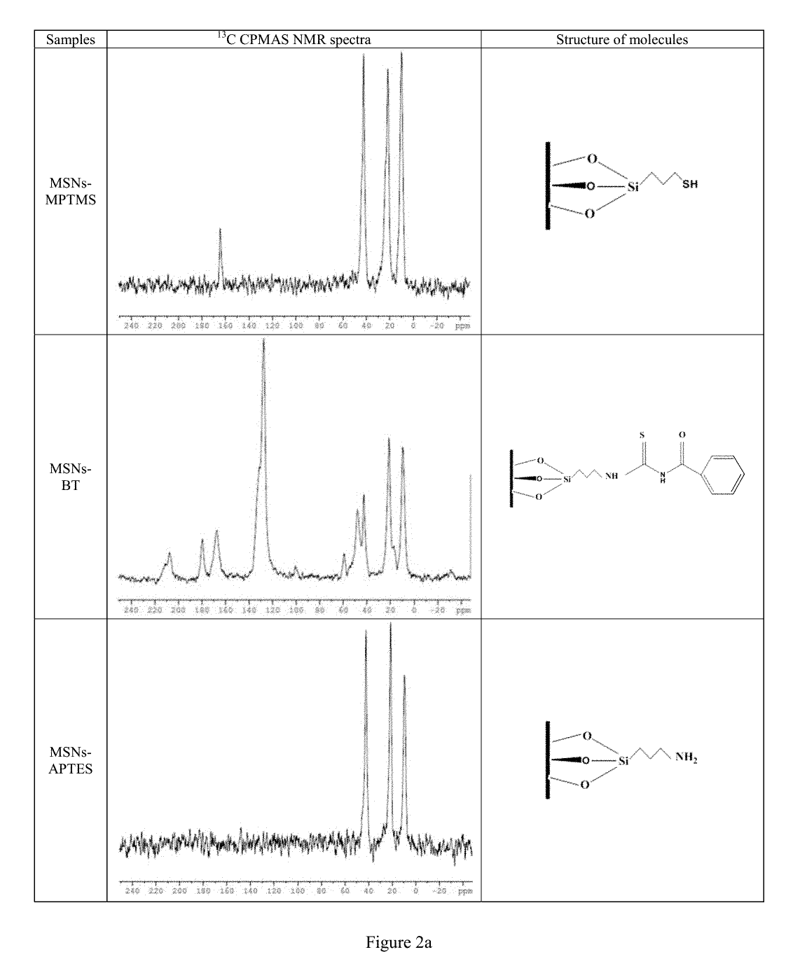

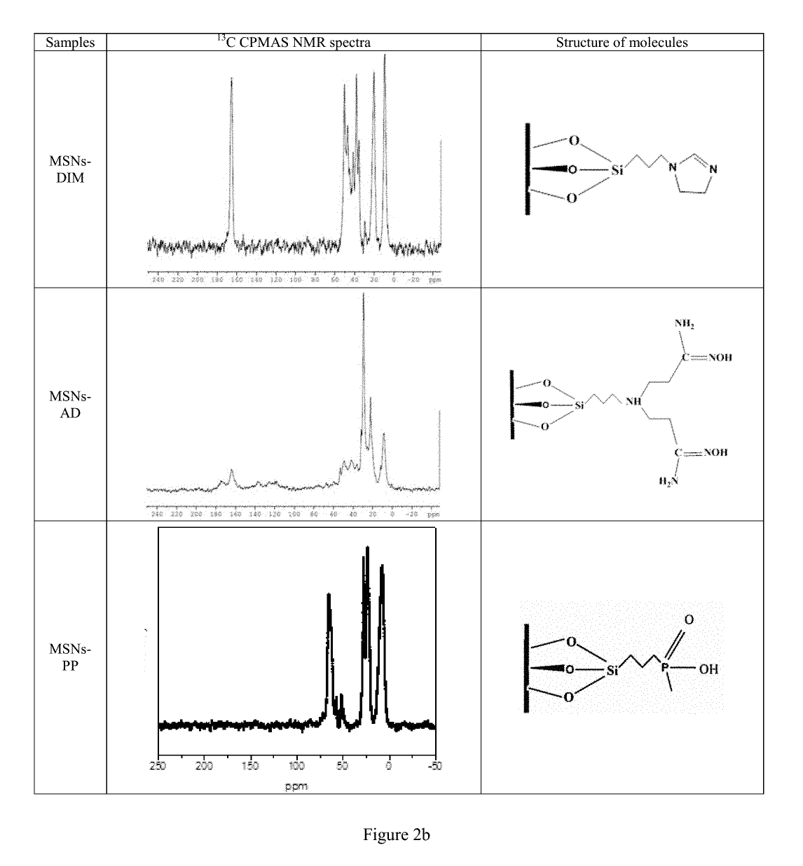

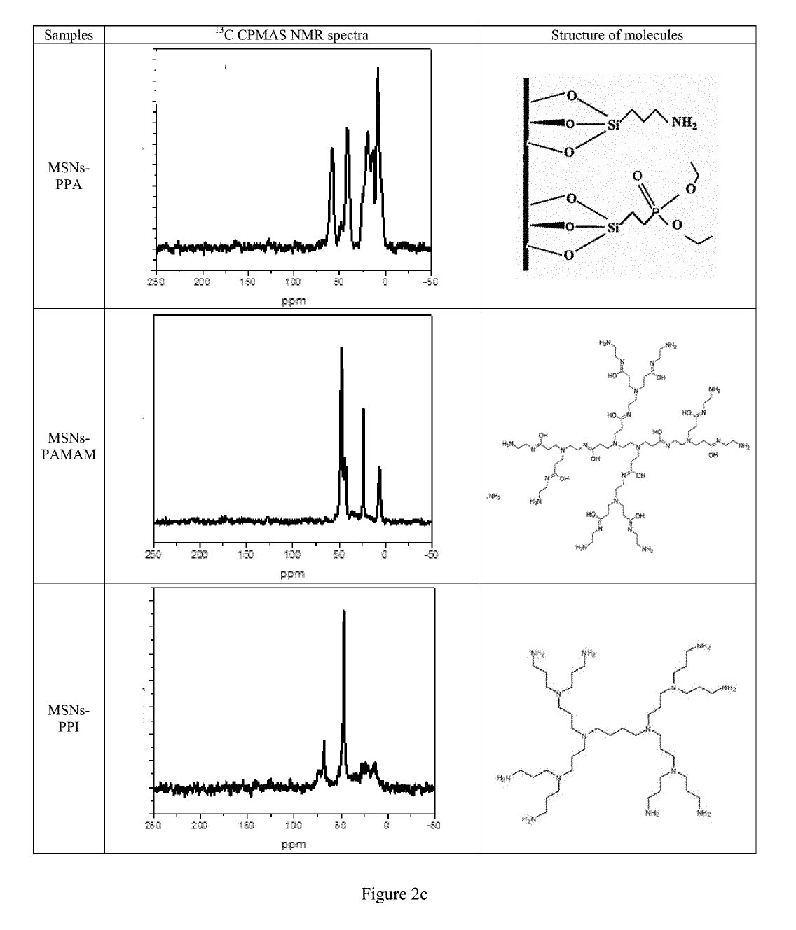

In addition, ¹³C CPMAS NMR spectra were also obtained to confirm the functionalization of the MMSNs. However, because the magnetite of the MMSNs interfered with the NMR spectroscopic measurements, the corresponding MSNs were used as controls to verify that the molecules were functionalized onto the surface of the MSNs and therefore also the MMSNs. The spectra and corresponding structures of the molecules are shown in FIGS. 2a, 2b, and 2c below.

### Example 15

### X-Ray Diffraction

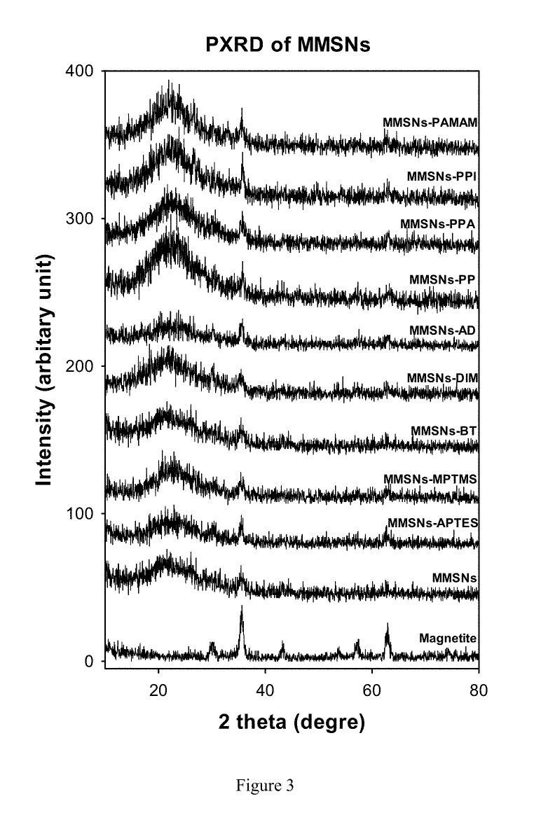

Powder XRD patterns of functionalized MMSNs were obtained and compared to that of nano-size magnetite. The patterns indicated the presence of magnetite and amorphous mesoporous silica (MCM-41). The patterns are shown in FIG. 3.

### Example 16

### Uranium Removal From Artificial Groundwater

Experiments were conducted to determine the removal of U(VI) from artificial groundwater. In particular, batch U(VI) sorption experiments were set up at a constant total U(VI) concentration (2.5×10⁻⁵ M) in AGW solution under ambient atmospheric CO₂ which was done by exposing the AGW to atmospheric air for three days inside an air-flowing hood.

For each set of experiments, a solid-free control was included in doublet. The purpose of these controls was to determine the initial uranium concentration for K_{d} calculation and to provide an indication if any uranium sorption to the tube walls occurred during the experiment.

About 0.075 gram of MMSNs and 7.5 mL AGW were added into a 15 mL polypropylene centrifuge tube while exposed to air. The resulting solid concentration was 10 g/L. Uranyl nitrate was used to make the uranium stock solution (5×10⁻³ M, pH 4.6, Eh 433 mV). After spiking 0.0375 mL of the uranium stock solution and then adjusting the pH using a 1 M NaOH or a 1 M HNO₃ solution to obtain the desired pH, the suspensions were placed on a shaker for 6 days for the sorption reaction. All tubes were open to atmospheric CO₂ once per day and for 60 minutes each time to promote equilibration with atmospheric CO₂. The pH values were adjusted daily until the pH shifts were <0.1 pH unit.

Each suspension was filtered using 0.2 μm nylon membrane syringe filters. The filtrate was acidified with 2% HNO₃ and analyzed for uranium by inductively coupled plasma mass spectrometry (ICP-MS). The ICP-MS analyses had an uncertainty of±10%, but the repeatability test indicated that this uncertainty was often within±5%. The extent of uranium sorption to the MMSNs was calculated using a distribution coefficient, K_{d} value, which is a uranium concentration ratio of sediment to solution. The K_{d} values (mL/g) were calculated using equation 1:

$${K}_{d} = \frac{{C}_{0} - C}{C} \times \frac{V}{M} \qquad ( 1 )$$

where C₀ is the initial uranium concentration in the control samples and C is the final uranium concentration in solutions, V is the volume of the solution (mL) and M is the mass of the MMSNs (g). In addition, the quantity of uranium adsorbed on the MMSNs was calculated according to equation 2.

$${q}_{e} = \frac{( {C}_{0} - C ) \times V}{M} \qquad ( 2 )$$

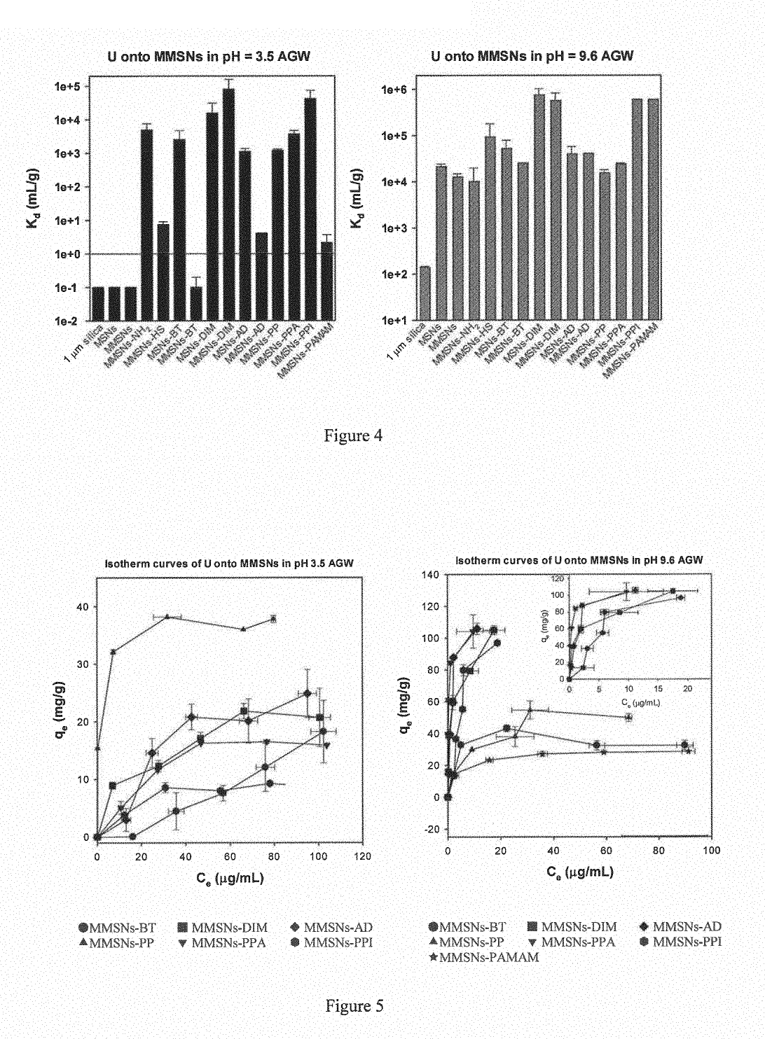

The adsorption coefficient (K_{d}) values of uranium onto the functionalized MMSNs with a pH=3.5 and pH=9.6 for the artificial groundwater are presented in FIG. 4, in comparison with those for silica and non-functionalized MSNs and MMSNs.

In the pH=3.5 for the artificial groundwater, the adsorption coefficient of uranium onto non-functionalized MSNs and MMSNs and silica were nearly zero, while the K_{d} values of uranium onto the functionalized MMSNs were of the magnitude of 4-6 orders greater than those for non-functionalized nanoparticles. Among them, MMSNs-PP had the greatest K_{d} value (>10,000 mL/g).

In the pH=9.6 for the artificial groundwater, the adsorption coefficient of uranium onto the non-functionalized MSNs and MMSNs were of the magnitude of 2 orders greater than that for silica, while the K_{d} values for the functionalized MMSNs were of the magnitude of additional 1-2 orders greater than the non-functionalized nanoparticles. Among them, MMSNs-DIM, MMSNs-PAMAM and MMSNs-PPI had the greatest K_{d} values (>600,000 mL/g, beyond the lower detection limit of uranium).

The isotherm curves of uranium onto functionalized MMSNs in the pH=3.5 and pH=9.6 for the artificial groundwater are shown in FIG. 5. In the pH=3.5 for the artificial groundwater, the adsorption capacities of MMSNs-DIM and MMSNs-AD were similar, at 30-35 mg/g, which are higher than that for MMSNs-BT (<10 mg/g). In the pH=9.6 for the artificial groundwater, the adsorption capacities of MMSNs-DIM and MMSNs-AD were at 120-150 mg/g, also higher than that for MMSNs-BT (˜80 mg/g).

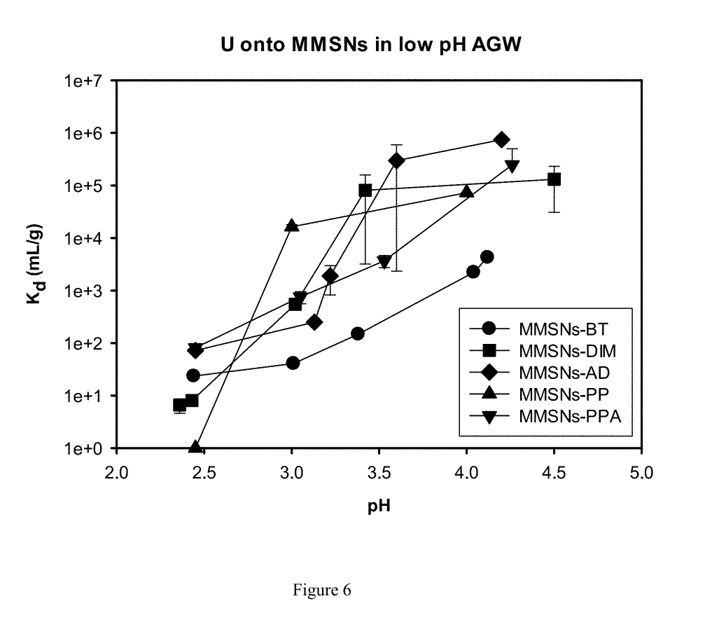

However, in the lower pH artificial groundwater systems, the effectiveness of the functionalized MMSNs might be dependent on the pH. For example, as shown in FIG. 6, the adsorption coefficients of uranium onto MMSNs-DIM could be >100,000 mL/g in the pH >3.5 for the artificial groundwater; while they could become nearly zero in the pH=2.5 artificial groundwater systems.

### Example 17

### Uranium Removal From Seawater

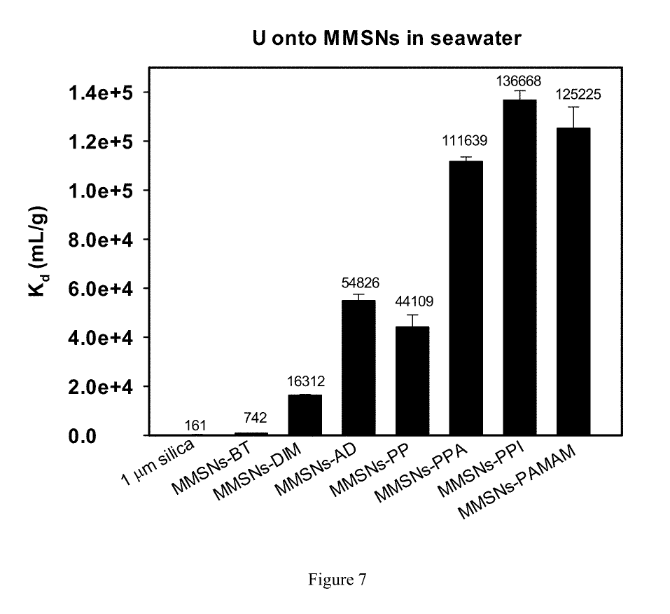

Similarly, batch experiments were set up to evaluate the effectiveness of some of the functionalized MMSNs for uranium extraction from a seawater simulant (pH=8.1). As shown in FIG. 7, MMSNs-BT were not as effective in extraction of uranium from the seawater. However, the functionalized MMSNs-DIM and MMSNs-AD were effective in removal of uranium from the seawater simulant (high ion strength, high carbonate). The adsorption coefficients of uranium onto the functionalized MMSNs were very high, up to 136,000 mL/g, demonstrating that they were fairly effective and selective in the extraction of uranium from the seawater.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method for removing uranium from a uranium containing aqueous medium, the method comprising:
contacting the medium with magnetic mesoporous silica nanoparticles each comprising mesoporous silica and iron oxide.

2. The method according to claim 1, wherein the iron oxide is Fe₃O₄.

3. The method according to claim 1, wherein the iron oxide is Fe₂O₃.

4. The method according to claim 1, wherein the magnetic mesoporous silica nanoparticles have an average particle size of from 1 to 500 nm.

5. The method according to claim 1, wherein the magnetic mesoporous silica nanoparticles have an average pore size of from 0.5 nm to 50 nm.

6. The method according to claim 1, wherein the magnetic mesoporous silica nanoparticles have an average surface area of from 50 m²/g to 2500 m²/g.

7. The method according to claim 1, wherein the magnetic mesoporous silica nanoparticles comprise a functional group bound to the nanoparticles.

8. The method according to claim 7, wherein the functional group comprises a sulfur atom, a nitrogen atom, a phosphorus atom, or a combination thereof.

9. The method according to claim 7, wherein the functional group is obtained from at least one of mercaptopropyl trimethoxysilane, benzoylthiourea, aminopropyl triethoxysilane, N-(3-triethoxysilylpropyl)-4,5 dihydroimidazole, polyacryloamidoxime, a phosphonate, a phosphonate amino, poly(amidoamine) dendrimer, and polypropylenimine dendrimer.

10. The method according to claim 7, wherein the functional group comprises a nitrogen containing heterocycle.

11. The method according to claim 7, wherein the functional group comprises an amine, a thiol, a phosphine, a phosphonate, a phosphonite, or a combination thereof.

12. The method according to claim 1, the method further comprising exposing the magnetic mesoporous silica nanoparticles to a magnetic field.

13. The method according to claim 1, wherein the contacting step results in uranium adsorbing to the magnetic mesoporous silica nanoparticles.

14. The method according to claim 13, further comprising separating the magnetic mesoporous silica nanoparticles with the adsorbed uranium from the medium.

15. The method according to claim 14, further comprising desorbing the adsorbed uranium from the magnetic mesoporous silica nanoparticles to provide desorbed uranium.

16. The method according to claim 15, further comprising separating the desorbed uranium from the magnetic mesoporous silica nanoparticles.

17. The method according to claim 16, further comprising reusing the separated magnetic mesoporous silica nanoparticles.

18. A magnetic mesoporous nanoparticle produced according to the method of claim 13, wherein the magnetic mesoporous nanoparticle comprises mesoporous silica, iron oxide, and uranium adsorbed to the magnetic mesoporous silica nanoparticle.
